(19) United States
(12) Patent Application Publication
(10) Pub. No.: US 2013/0294012 A1
(43) Pub. Date: Nov. 7, 2013

(54) ELECTROCHEMICAL DEVICE

(71) Applicant: TAIYO YUDEN CO., LTD., Tokyo (JP)

(72) Inventors: Kyotaro MANO, Tokyo (JP); Yuki KAWAI, Tokyo (JP); Naoto HAGIWARA, Tokyo (JP); Katsuei ISHIDA, Tokyo (JP)

(73) Assignee: Taiyo Yuden Co., Ltd., Tokyo (JP)

(21) Appl. No.: 13/873,452

(22) Filed: Apr. 30, 2013

(30) Foreign Application Priority Data
May 1, 2012 (JP) 2012-104310

(51) Int. Cl. H01G 9/145

(52) U.S. Cl. CPC H01G 9/145
USPC 361/517

(57) ABSTRACT

An electrochemical device includes a casing, a storage element, an electrolyte, a wiring, and an adhesive layer. The casing forms a liquid chamber, the liquid chamber having a bottom surface provided with a recess. The storage element is housed in the liquid chamber. The electrolyte is housed in the liquid chamber. The wiring is connected to the recess. The adhesive layer is made of a conductive adhesive filled in the recess and configured to coat the wiring and cause the storage element to adhere to the casing.

### CROSS-REFERENCE TO RELATED APPLICATION

This application claims priority under 35 U.S.C. §119 to Japanese Patent Application No. JP2012-104310 filed on May 1, 2012, the entire content of which is hereby incorporated herein by reference in its entirety.

### FIELD

The present disclosure relates to an electrochemical device including a chargeable/dischargeable storage element.

### BACKGROUND

Electrochemical devices each including a chargeable/dischargeable storage element, for example, electric double-layer capacitors or lithium-ion capacitors have been widely used for a back-up power supply and the like. In general, such an electrochemical device has a structure in which a storage element and an electrolyte are sealed in an insulating casing. A wiring is formed in the insulating casing. The wiring is in conduction with the sealed storage element.

Here, in such an electrochemical device, it is necessary to protect a wiring from galvanic corrosion due to the charge/discharge of the storage element. For example, Japanese Patent Application Laid-open No. 2001-216952 (hereinafter, referred to as Patent Document 1) describes “battery of nonaqueous electrolyte and capacitor with electrically double layers” in which a wiring is made of a metal having high corrosion resistance such as gold and silver. Further, Japanese Patent Application Laid-open No. 2006-303381 (hereinafter, referred to as Patent Document 2) describes “electric double layer capacitor and battery” in which a configuration in which the wiring is coated by a protective layer made of a conductive adhesive is employed.

### SUMMARY

However, in the case where the wiring is made of a metal having high corrosion resistance as described in Patent Document 1, the types of metals to be used are limited. For example, high-melting-point metals are unusable. Thus, there is a problem in that it is difficult to manufacture the wiring by a manufacturing process in which heating at high temperature is necessary. Further, in the configuration in which the wiring is coated with the conductive adhesive as described in Patent Document 2, there is a fear that, when an electrode is placed after the conductive adhesive is applied to an electrode placement surface, the conductive adhesive is pushed away with the result that the wiring is exposed.

In view of the above-mentioned circumstances, it is desirable to provide an electrochemical device capable of effectively protecting a wiring from galvanic corrosion.

According to an embodiment of the present disclosure, there is provided an electrochemical device including a casing, a storage element, an electrolyte, a wiring, and an adhesive layer.

The casing forms a liquid chamber, the liquid chamber having a bottom surface provided with a recess.

The storage element is housed in the liquid chamber.

The electrolyte is housed in the liquid chamber.

The wiring is connected to the recess.

The adhesive layer is made of a conductive adhesive filled in the recess and configured to coat the wiring and cause the storage element to adhere to the casing.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a perspective view of an electrochemical device according to an embodiment of the present disclosure;

FIG. 2 is a cross-sectional view of the electrochemical device;

FIG. 3 is a plan view of the electrochemical device;

FIGS. 4A and 4B are schematic views each showing a recess of the electrochemical device;

FIGS. 5A and 5B are schematic views each showing the filling of a conductive adhesive into the recess of the electrochemical device and the provision of a storage element;

FIGS. 6A and 6B are schematic views each showing the conductive adhesive filled in the recess of the electrochemical device;

FIG. 7 is a cross-sectional view of the electrochemical device;

FIG. 8 is a cross-sectional view of the electrochemical device; and

FIG. 9 is a cross-sectional view of the electrochemical device.

### DETAILED DESCRIPTION OF THE EMBODIMENTS

According to an embodiment of the present disclosure, there is provided an electrochemical device including a casing, a storage element, an electrolyte, a wiring, and an adhesive layer.

The casing forms a liquid chamber, the liquid chamber having a bottom surface provided with a recess.

The storage element is housed in the liquid chamber.

The electrolyte is housed in the liquid chamber.

The wiring is connected to the recess.

The adhesive layer is made of a conductive adhesive filled in the recess and configured to coat the wiring and cause the storage element to adhere to the casing.

With this configuration, the wiring is coated with the adhesive layer. Therefore, contact of the electrolyte to the wiring is prevented. That is, galvanic corrosion of the wiring by the electrolyte is prevented. With this, the kind of metal to be used for the wiring can be selected irrespective of corrosion resistance with respect to the electrolyte.

The recess does not need to be opposed to an entire area of the storage element, the entire area being opposed to the bottom surface.

With this configuration, the storage element does not enter the recess. Therefore, the conductive adhesive filled in the recess is prevented from being pushed out by the storage element. Adhesion of the storage element to the casing and an electrical connection between the storage element and the wiring are ensured.

The wiring may include a via-hole formed from an inside of the casing to the recess.

With this configuration, the wiring can be connected to the recess through the via-hole.

The recess may have a depth of no less than 10 μm and no more than 150 μm.

With this configuration, a thickness of the adhesive layer made of the conductive adhesive filled in the recess can be set to be no less than 10 μm and no more than 150 μm. By setting the thickness of the adhesive layer to be no less than 10 μm, the wiring can be reliably coated. By setting the thickness of the adhesive layer to be no more than 150 μm, the electrochemical device can be reduced in height.

The casing may be made of high temperature co-fired ceramics (HTCC), and the wiring may be made of a metal having a melting point higher than a sintering temperature of the HTCC.

In the case where the casing is made of high temperature co-fired ceramics (HTCC), the material of the wiring needs to be selected from high-melting-point metals (e.g., tungsten) resisting the sintering temperature of the HTCC. However, the high-melting-point metals have relatively low corrosion resistance and hence can suffer from galvanic corrosion due to the electrolyte. However, as described above, the wiring is coated with the adhesive layer and contact with the electrolyte is prevented. Therefore, the wiring can be made of a high-melting-point metal having low corrosion resistance.

The conductive adhesive may be a phenol resin including a conductive particle.

The phenol resin has characteristics such as a high chemical stability, a low swelling property with respect to the electrolyte, and high thermal resistance. Therefore, by utilizing the conductive adhesive made of the phenol resin including the conductive particle, it becomes possible to effectively protect the wiring. In addition, the phenol resin has a thermosetting property, and hence can be cured by heating.

The storage element may include a first electrode sheet including an active material, a separate sheet made of a porous material, and a second electrode sheet including an active material. The electrode sheet, the separate sheet, and the second electrode sheet are stacked. The first electrode sheet may adhere to the casing via the adhesive layer.

With this configuration, in the electrochemical device including the storage element in which the first electrode sheet, the separate sheet, and the second electrode sheet are stacked, it is possible to effectively protect the wiring from galvanic corrosion.

An electrochemical device according to an embodiment of the present disclosure will be described.

### Configuration of Electrochemical Device

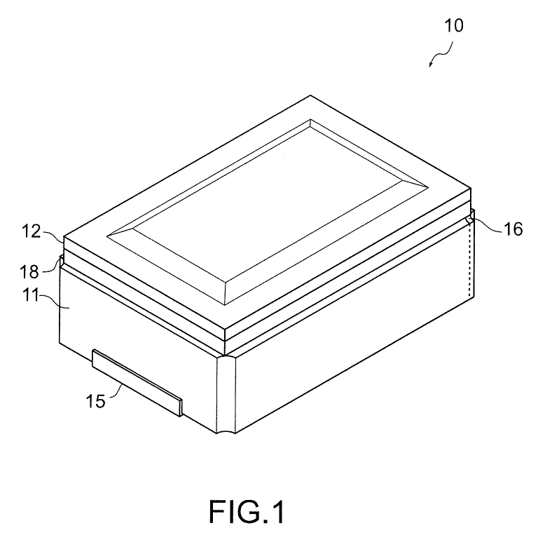

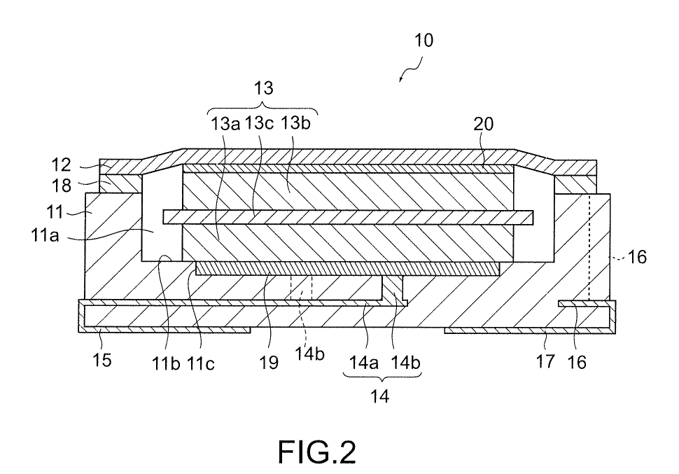

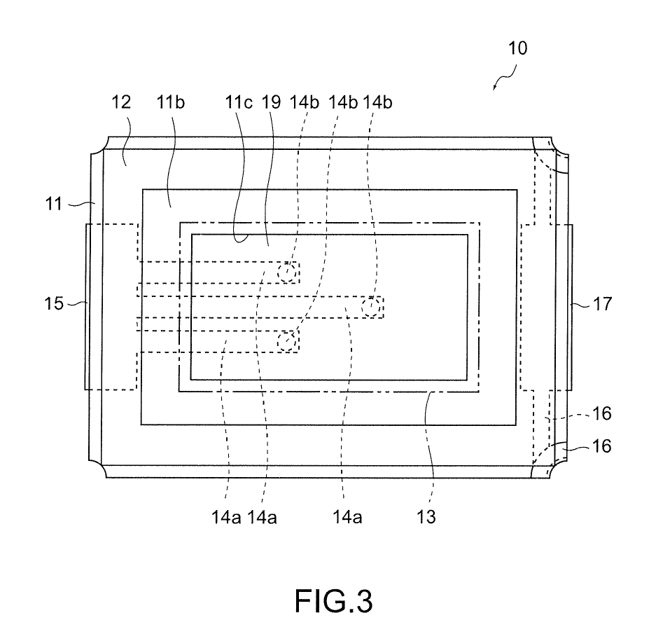

FIG. 1 is a perspective view of an electrochemical device 10 according to this embodiment. FIG. 2 is a cross-sectional view of the electrochemical device 10. FIG. 3 is a plan view of the electrochemical device 10. As shown in those figures, the electrochemical device 10 includes a casing 11, a lid 12, a storage element 13, a positive-electrode wiring 14, a positive-electrode terminal 15, a negative-electrode wiring 16, a negative-electrode terminal 17, a coupling ring 18, a positive-electrode adhesive layer 19, and a negative-electrode adhesive layer 20.

As shown in FIG. 2, the electrochemical device 10 is configured by joining the casing 11 to the lid 12 via the coupling ring 18 and sealing the storage element 13 and the electrolyte in a liquid chamber 11a thus formed. Although will be described later in detail, the positive-electrode wiring 14 passes through an inside of the casing 11 and electrically connects a positive electrode of the storage element 13 to the positive-electrode terminal 15. The negative-electrode wiring 16 passes through the inside of the casing 11 and electrically connects a negative electrode of the storage element 13 to the negative-electrode terminal 17.

The casing 11 is made of an insulating material such as ceramics, and forms the liquid chamber 11a together with the lid 12. The casing 11 may be formed in a recess shape so as to form the liquid chamber 11a. For example, the casing 11 may be formed in a rectangular parallelepiped shape as shown in FIG. 1 or in another shape such as a cylindrical shape. A surface corresponding to the bottom surface of the liquid chamber 11a of the casing 11 is referred to as a bottom surface 11b. A recess 11c is formed at the center of the bottom surface 11b. The recess 11c will be described later in detail.

The lid 12 is joined to the casing 11 via the coupling ring 18 to seal the liquid chamber 11a. The lid 12 may be made of a conductive material such as various types of metals. For example, the lid 12 may be made of kovar (iron-nickel-cobalt alloy). Alternatively, the lid 12 may be made of a clad material having a matrix of kovar or the like covered with a film made of a metal having high corrosion resistance such as nickel, platinum, silver, gold, and palladium in order to prevent galvanic corrosion.

The lid 12 is joined to the casing 11 via the coupling ring 18 to seal the liquid chamber 11a. For coupling of the lid 12 to the coupling ring 18, in addition to a direct joining method such as seam welding or laser welding, an indirect joining method using a conductive joining material may be utilized.

The storage element 13 is housed in the liquid chamber 11a. The storage element 13 stores charges (electricity) or discharges charges (electricity). As shown in FIG. 2, the storage element 13 includes a first electrode sheet 13a, a second electrode sheet 13b, and a separate sheet 13c. The first electrode sheet 13a and the second electrode sheet 13b may sandwich the separate sheet 13c therebetween. The storage element 13 may be placed on the bottom surface 11b such that the first electrode sheet 13a is on a side of the bottom surface 11b.

Constituent materials of the first electrode sheet 13a, the second electrode sheet 13b, and the separate sheet 13c may be appropriately selected depending on necessary properties. For example, the first electrode sheet 13a and the second electrode sheet 13b may be made of a material including an active material selected among an active charcoal, a black lead (graphite), a polyacene-based organic semiconductor (PAS), and the like. The separate sheet 13c may be made of a porous sheet including glass fibers, cellulose fibers, plastic fibers, or the like as a main material.

The materials of the first electrode sheet 13a, the second electrode sheet 13b, and the separate sheet 13c may be the same or different depending on the type of the electrochemical device 10. For example, in the case where the electrochemical device 10 is an electric double-layer capacitor, the first electrode sheet 13a and the second electrode sheet 13b may be made of the same material. In the case where the electrochemical device 10 is a lithium-ion capacitor, the first electrode sheet 13a and the second electrode sheet 13b may be made of different materials.

The electrolyte to be housed together with the storage element 13 in the liquid chamber 11a may also be arbitrarily selected. For example, in the case where the electrochemical device 10 is an electric double-layer capacitor, the electrolyte may be an electrolyte obtained by dissolving electrolyte salt in a solvent. In the case where the electrochemical device 10 is a lithium-ion capacitor, the electrolyte may be an electrolyte obtained by dissolving lithium salt in a solvent.

The positive-electrode wiring 14 electrically connects (the first electrode sheet 13a of) the storage element 13 to the positive-electrode terminal 15. Specifically, the positive-electrode wiring 14 includes band-like portions 14a and via-portions 14b. The band-like portions 14a pass through the inside of the casing 11 from the positive-electrode terminal 15 to directly below the recess 11c. The via-portions 14b are formed to extend from the band-like portions 14a toward the casing 11. A plurality of band-like portions 14a and a plurality of via-portions 14b may be provided.

The via-portions 14b are connected to the recess 11c. The via-portions 14b are held in contact with the positive-electrode adhesive layer 19 filled in the recess 11c and having conductivity. The via-portions 14b are in conduction with a first electrode 3a via the positive-electrode adhesive layer 19. The positive-electrode wiring 14 may be made of a conductive material such as various kinds of metals. Although will be described later in detail, the via-portions 14b are protected by the positive-electrode adhesive layer 19 from galvanic corrosion. Therefore, materials of the positive-electrode wiring 14 may be selected from a wide range of materials irrespective of corrosion resistance. For example, the positive-electrode wiring 14 may be made of tungsten. The via-portions 14b may be obtained by forming a nickel film and a gold film on tungsten.

The positive-electrode terminal 15 is connected to the positive electrode (first electrode sheet 13a) of the storage element 13 by the positive-electrode wiring 14. The positive-electrode terminal 15 is used for connection to an outside, for example, a mounting substrate. The positive-electrode terminal 15 may be made of an arbitrary conductive material. As shown in FIG. 2, the positive-electrode terminal 15 may be formed from a side surface to a lower surface of the casing 11.

The negative-electrode wiring 16 electrically connects (the second electrode sheet 13b) of the storage element 13 and the negative-electrode terminal 17. Specifically, the negative-electrode wiring 16 may be formed along an outer periphery of the casing 11 from the negative-electrode terminal 17 and connected to the coupling ring 18. The negative-electrode wiring 16 is in conduction with the second electrode sheet 13b via the coupling ring 18, the lid 12, and the negative-electrode adhesive layer 20 having conductivity. The negative-electrode wiring 16 may be made of an arbitrary conductive material.

The negative-electrode terminal 17 is connected to the negative electrode (second electrode sheet 13b) of the storage element 13 by the negative-electrode wiring 16. The negative-electrode terminal 17 is used for connection to the outside, for example, the mounting substrate. The negative-electrode terminal 17 may be made of an arbitrary conductive material. As shown in FIG. 2, the negative-electrode terminal 17 may be formed from the side surface to the lower surface of the casing 11.

The coupling ring 18 connects the casing 11 to the lid 12 to seal the liquid chamber 11a. The coupling ring 18 electrically connects the lid 12 to the negative-electrode wiring 16. The coupling ring 18 may be made of a conductive material such as kovar (iron-nickel-cobalt alloy). Further, a corrosion-resistant film (e.g., nickel film and metal film) may be formed on a surface of the coupling ring 18. The coupling ring 18 may be joined to the casing 11 and the lid 12 via a brazing material (gold-copper alloy or the like).

The positive-electrode adhesive layer 19 causes the first electrode sheet 13a to adhere to the casing 11. The positive-electrode adhesive layer 19 electrically connects the first electrode sheet 13a to the positive-electrode wiring 14. The positive-electrode adhesive layer 19 is obtained by curing the conductive adhesive filled in the recess 11c. The conductive adhesive may be a synthetic resin including a conductive particle. The conductive particle is, for example, a carbon particle (carbon black), or a black lead particle (graphite particle). The synthetic resin may be a thermosetting resin such as a phenol resin and an epoxy-based resin. In particular, a phenol resin is favorable in view of a low swelling property with respect to the electrolyte, high thermal resistance, a high chemical stability, and the like. The conductive adhesive may be made of any material as long as it is conductive and curable.

As shown in FIG. 2, the positive-electrode adhesive layer 19 is formed in the recess 11c and coats (the via-portions 14b of) the positive-electrode wiring 14 connected to the recess 11c. With this, the electrolyte housed in the liquid chamber 11a is prevented from being brought into contact with the positive-electrode wiring 14 to protect the positive-electrode wiring 14 from galvanic corrosion.

The negative-electrode adhesive layer 20 causes the second electrode sheet 13b to adhere to the lid 12. The negative-electrode adhesive layer 20 electrically connects the second electrode sheet 13b to the lid 12. The negative-electrode adhesive layer 20 is obtained by curing the conductive adhesive. As in the positive-electrode adhesive layer 19, the conductive adhesive may be a synthetic resin including a conductive particle. Note that the negative-electrode adhesive layer 20 and the positive-electrode adhesive layer 19 may be made of the same kind of conductive adhesive or a different kind of conductive adhesive.

Note that the casing 11 may be high temperature co-fired ceramics (HTCC) sintered together with the positive-electrode wiring 14, the positive-electrode terminal 15, the negative-electrode wiring 16, and the negative-electrode terminal 17 at a high temperature. During sintering, those components becomes one heated to a high temperature. The positive-electrode wiring 14, the positive-electrode terminal 15, the negative-electrode wiring 16, and the negative-electrode terminal 17 need to be made of a high-melting-point metal (e.g., tungsten). That is, in the case where the casing 11 is made of HTCC, metals generally having high corrosion resistance (gold, silver, platinum, etc.) are unusable. Thus, in the case where the casing 11 is made of the HTCC, it is highly necessary to protect the positive-electrode wiring 14 and the like made of a metal having relatively low corrosion resistance from galvanic corrosion.

### Recess

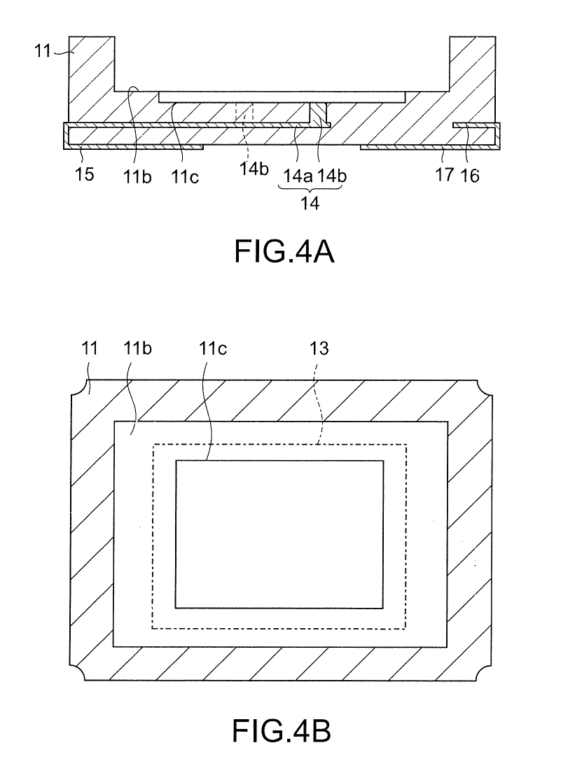

The recess 11c provided in the casing 11 will be described in detail. FIGS. 4A and 4B are schematic views each showing the recess 11c. FIG. 4A is a cross-sectional view of the casing 11. FIG. 4B is a plan view of the casing 11.

As shown in FIGS. 4A and 4B, the recess 11c may be formed at the center of the bottom surface 11b being a bottom surface of the liquid chamber 11a. The recess 11c favorably has a depth of no less than 10 μm and no more than 150 μm. That is because a thickness (to be described later) of the positive-electrode adhesive layer 19 depends on the depth of the recess 11c. Note that the depth of the recess 11c does not need to be even.

Further, as shown in FIG. 4B, the recess 11c is formed in a shape such that the recess 11c is not opposed to an entire area of the storage element 13, the entire area being opposed to the bottom surface 11b (hereinafter, referred to as opposed area). That is, the recess 11c is formed in a shape such that at least part of the opposed area protrudes from the recess 11c. That is because the storage element 13 does not enter the recess 11c. Specifically, as shown in FIG. 4B, the recess 11c may be formed to have a size smaller than the opposed area. Further, the shape of the recess 11c is not limited to a rectangular shape, and may be a circular shape, an elliptical shape, a rhombic shape, or the like. On the other hand, the recess 11c is favorably as large as possible within a range in which the recess 11c is not opposed to the entire opposed area. That is because the area of the positive-electrode adhesive layer 19 depends on the area of the recess 11c (to be described later).

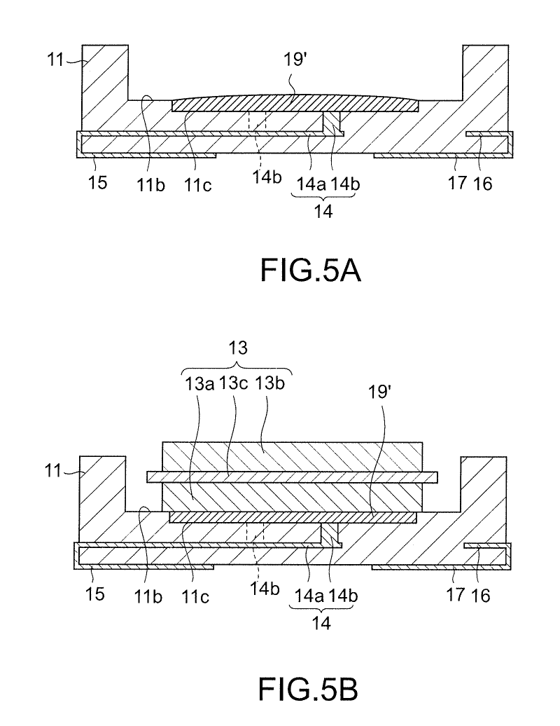

The filling of the conductive adhesive into the recess 11c and the provision of the storage element 13 will be described. FIGS. 5A and 5B are schematic views each showing the filling of a conductive adhesive 19′ into the recess 11c and the provision of the storage element 13. FIG. 5A shows the conductive adhesive 19′ filled in the recess 11c. FIG. 5B shows the storage element 13 provided on the conductive adhesive 19′.

As shown in FIG. 5A, the conductive adhesive 19′ is filled in the recess 11c. At this time, it is favorable that such an amount of conductive adhesive 19′ is filled in the recess 11c that the conductive adhesive 19′ is raised from the bottom surface 11b due to surface tension. That is for ensuring adhesion of the storage element 13 to the casing 11 and an electrical connection between the positive-electrode wiring 14 and the storage element 13. By filling the conductive adhesive 19′ into the recess 11c, the via-portions 14b of the positive-electrode wiring 14 connected to the recess 11c are coated with the conductive adhesive 19′.

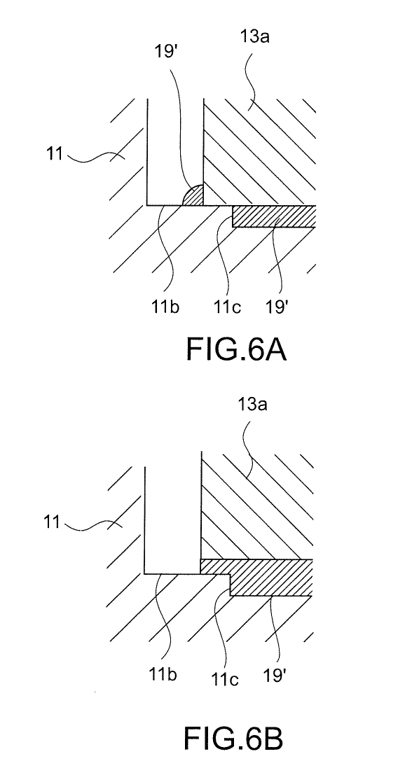

As shown in FIG. 5B, the storage element 13 is placed on the conductive adhesive 19′ filled in the recess 11c, and adhere to the casing 11 via the conductive adhesive 19′. FIGS. 6A and 6B are enlarged views of FIG. 5B. As shown in FIG. 6A, excess conductive adhesive 19′ may be pushed onto the bottom surface 11b by the storage element 13. As shown in FIG. 6B, excess conductive adhesive 19′ may be present between the storage element 13 and the bottom surface 11b.

After the storage element 13 is placed, the conductive adhesive 19′ is cured to become the positive-electrode adhesive layer 19. In the case where the conductive adhesive 19′ is made of a thermosetting material, the conductive adhesive 19′ may be cured by heating. Note that, actually, after the lid 12 closes the liquid chamber 11a, the conductive adhesive 19′ may be cured together with the conductive adhesive to become the negative-electrode adhesive layer 20.

In the above description, the storage element 13 in which the first electrode sheet 13a, the separate sheet 13c, and the second electrode sheet 13b are integrated with each other adheres to the casing 11 via the conductive adhesive 19′. However, the present disclosure is not limited thereto. For example, only the first electrode sheet 13a may be bonded to the conductive adhesive 19′. In this case, the second electrode sheet 13b is bonded to the lid 12 via the conductive adhesive to become the negative-electrode adhesive layer 20. In a state in which the separate sheet 13c is placed on the first electrode sheet 13a, the lid 12 is joined to the casing 11, to thereby form the storage element 13.

In this manner, the positive-electrode adhesive layer 19 made of the conductive adhesive 19′ filled in the recess 11c fixes the storage element 13 to the casing 11 and coats the positive-electrode wiring 14. As the area of the positive-electrode adhesive layer 19 becomes larger, conductivity between the storage element 13 and the positive-electrode wiring 14 becomes higher, which is favorable. Thus, the recess 11c favorably has an area as large as possible within a range in which the recess 11c is not opposed to the entire opposed area.

Further, the positive-electrode adhesive layer 19 coats the positive-electrode wiring 14. Contact of the electrolyte to the positive-electrode wiring 14 is prevented. That is, galvanic corrosion of the positive-electrode wiring 14 is prevented. In order to prevent the contact of the electrolyte to the positive-electrode wiring 14, the positive-electrode adhesive layer 19 needs to have a thickness of at least 10 μm. That is, the recess 11c favorably has a depth of no less than 10 μm. On the other hand, for coating of the positive-electrode wiring 14, it is sufficient that the positive-electrode adhesive layer 19 has a thickness of 150 μm. That is, by setting the depth of the recess 11c to be no more than 150 μm, it is possible to reduce the height of the electrochemical device 10.

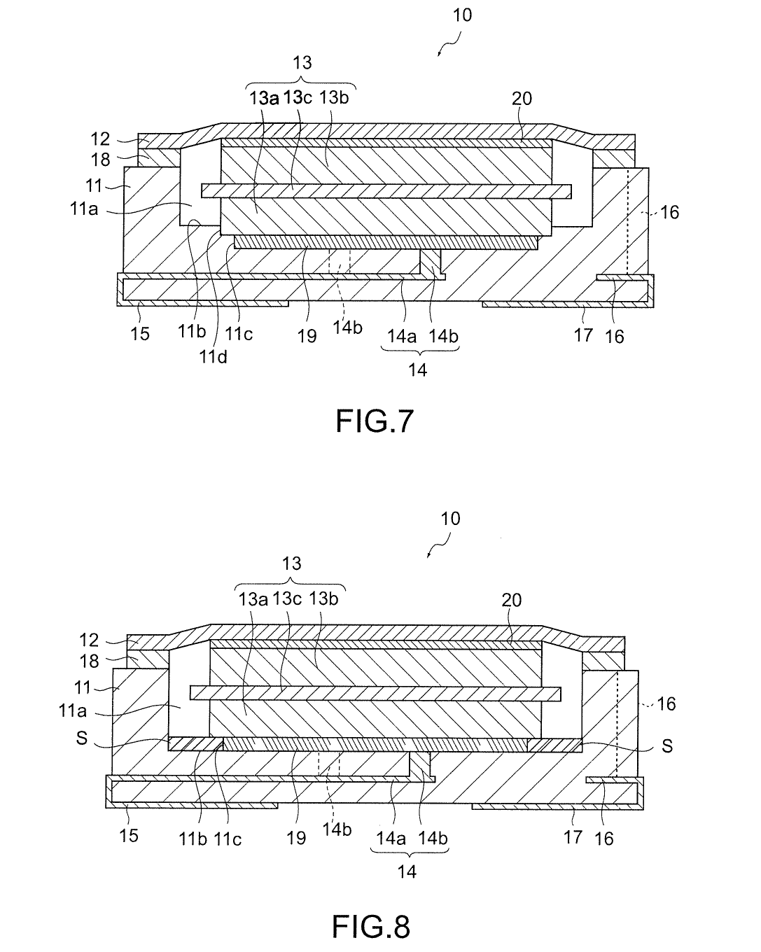

The recess 11c may be formed in an inside of another recess formed in the bottom surface 11b of the liquid chamber 11a. FIG. 7 is a schematic view showing the electrochemical device 10 having this recess. As shown in the figure, a second recess 11d is formed in the bottom surface 11b, and the recess 11c is formed in a step-like shape in an inside of the second recess 11d. The second recess 11d may be formed in a shape corresponding to the opposed area of the storage element 13.

With this, the storage element 13 fits into the second recess 11d. On the other hand, the recess 11c is formed in a shape such that the recess 11c is not opposed to the entire opposed area of the storage element 13. Therefore, the storage element 13 does not enter the recess 11c. With this, after the recess 11c is filled with the conductive adhesive to become the positive-electrode adhesive layer 19, it is possible to position the storage element 13, using the second recess 11d as a guide.

The present technology is not limited only to each of the above-mentioned embodiments and may be modified without departing from the gist of the present technology.

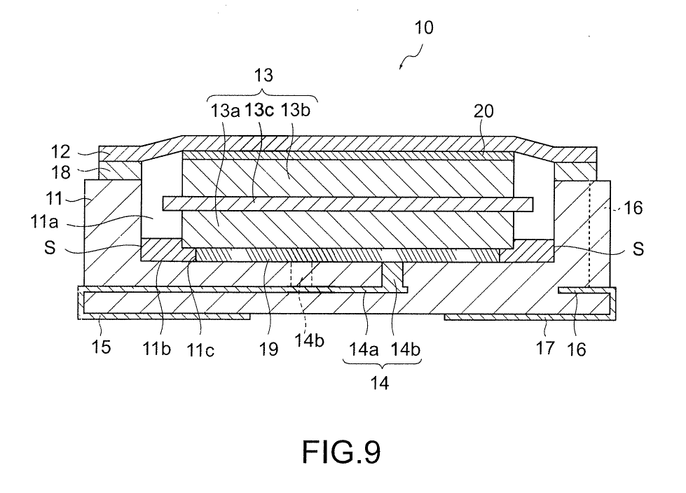

For example, the recess 11c may be formed by a spacer provided in the bottom surface 11b instead of machining the casing 11 itself. FIGS. 8 and 9 are schematic views each showing the recess 11c formed by a spacer S. Using the spacer S, the recess 11c can be formed without machining the casing 11 itself, and hence it is possible to make the manufacture of the casing 11 easier.

What is claimed is:

1. An electrochemical device, comprising:
a casing that forms a liquid chamber, the liquid chamber having a bottom surface provided with a recess;
a storage element housed in the liquid chamber;
an electrolyte housed in the liquid chamber;
a wiring connected to the recess; and
an adhesive layer that is made of a conductive adhesive filled in the recess and configured to coat the wiring and cause the storage element to adhere to the casing.

2. The electrochemical device according to claim 1, wherein
the recess is not opposed to an entire area of the storage element, the entire area being opposed to the bottom surface.

3. The electrochemical device according to claim 1, wherein
the wiring includes a via-hole formed from an inside of the casing to the recess.

4. The electrochemical device according to claim 1, wherein
the recess has a depth of no less than 10 μm and no more than 150 μm.

5. The electrochemical device according to claim 1, wherein
the casing is made of high temperature co-fired ceramics (HTCC), and
the wiring is made of a metal having a melting point higher than a sintering temperature of the HTCC.

6. The electrochemical device according to claim 1, wherein
the conductive adhesive is a phenol resin including a conductive particle.

7. The electrochemical device according to claim 1, wherein
the storage element includes
a first electrode sheet including an active material,
a separate sheet made of a porous material, and
a second electrode sheet including an active material, the electrode sheet, the separate sheet, and the second electrode sheet being stacked, and
the first electrode sheet adheres to the casing via the adhesive layer.
